(19) United States
(12) Patent Application Publication
(10) Pub. No.: US 2026/0264439 A1
(43) Pub. Date: Sep. 10, 2026

(54) IMAGE FORMING METHOD AND RECORDED MATTER

(71) Applicants: Takenori SUENAGA, Kanagawa (JP); Mizuki OKAWA, Kanagawa (JP)

(72) Inventors: Takenori SUENAGA, Kanagawa (JP); Mizuki OKAWA, Kanagawa (JP)

(21) Appl. No.: 19/439,488

(22) Filed: Jan. 5, 2026

(30) Foreign Application Priority Data
Mar. 5, 2025 (JP) 2025-034439

(51) Int. Cl. B41M 5/035; B41M 5/025; B41M 5/03

(52) U.S. Cl. CPC B41M 5/0356; B41M 5/0256; B41M 5/03; B41M 5/0358

(57) ABSTRACT

An image forming method is provided that includes: applying an ink to a transfer base material to form a transfer image; applying a binder powder onto the transfer image on the transfer base material to form a transfer film; and heat-pressing the transfer film onto a recording medium and then releasing the transfer base material to transfer the transfer image onto the recording medium. The binder powder includes a hot melt powder and a luster pigment having an average particle size of 10 μm or more and 1,000 μm or less, and a content of the luster pigment in the binder powder is 0.6% by mass or more and 15% by mass or less of the hot melt powder.

### CROSS-REFERENCE TO RELATED APPLICATION

This patent application is based on and claims priority pursuant to 35 U.S.C. § 119(a) to Japanese Patent Application No. 2025-034439, filed on Mar. 5, 2025, in the Japan Patent Office, the entire disclosure of which is hereby incorporated by reference herein.

### BACKGROUND

### Technical Field

The present disclosure relates to an image forming method and a recorded matter.

### Related Art

Direct To Film (“DTF”) printing is known as an example of an image forming method. In DTF printing, a coloring ink is applied to a transfer base material such as a film, and is heated to form an image to be transferred (hereinafter “a transfer image”). A DTF printed article is obtained by heat-pressing a transfer film, which is formed by spraying a hot melt powder onto the transfer image, onto a recording medium such as clothing, and then removing the transfer base material.

A technique is conventionally known in which an additive is added to a hot melt powder to impart decorative properties to a DTF printed article.

### SUMMARY

Embodiments of the present invention provides an image forming method that includes: applying an ink to a transfer base material to form a transfer image; applying a binder powder onto the transfer image on the transfer base material to form a transfer film; and heat-pressing the transfer film onto a recording medium and then releasing the transfer base material to transfer the transfer image onto the recording medium. The binder powder includes a hot melt powder and a luster pigment having an average particle size of 10 μm or more and 1,000 μm or less, and a content of the luster pigment in the binder powder is 0.6% by mass or more and 15% by mass or less of the hot melt powder.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a process diagram illustrating an image forming method;

FIG. 2 is a diagram illustrating an example of a recording device used in an image forming method; and

FIG. 3 is a diagram illustrating an example of a main tank in a recording device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present disclosure, an image forming method is provided that forms a recorded matter having excellent decorative properties.

Embodiments of the present disclosure are described below.

### <Image Forming Method>

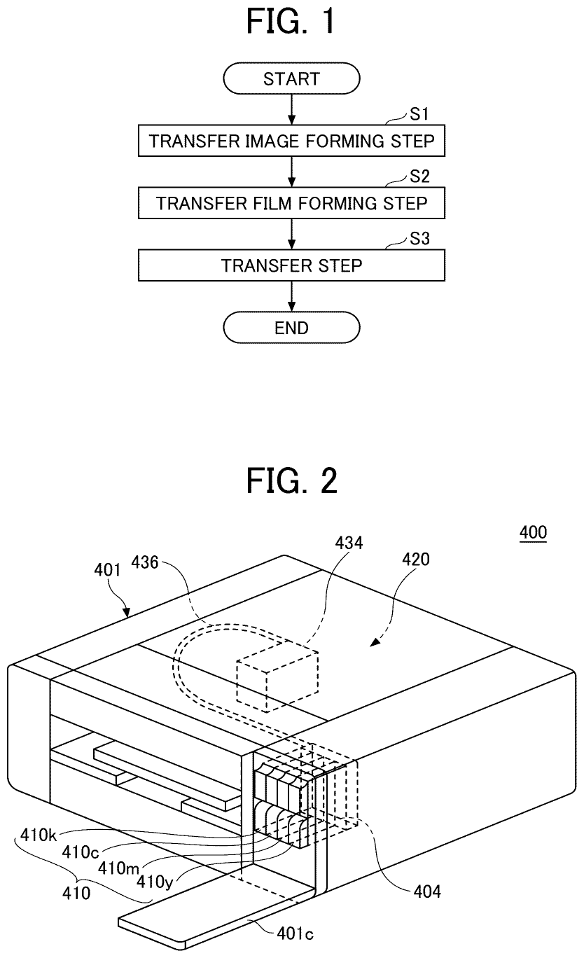

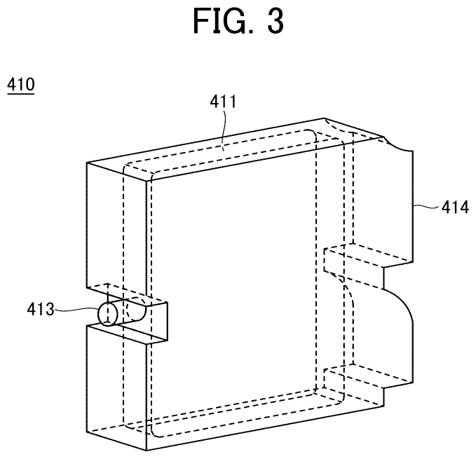

FIG. 1 is a process diagram illustrating an image forming method. The image forming method illustrated in FIG. 1 includes a transfer image forming step S1, a transfer film forming step S2, and a transfer step S3.

### <<Transfer Image Forming Step>>

In the transfer image forming step S1, an ink is applied to a transfer base material to form a transfer image.

### <<<Transfer Base Material>>>

The transfer base material is not particularly limited, and can be selected as appropriate. As the transfer base material, for example, a film formed of a polymer such as polyolefin or polyester can be used. It is preferable that a release layer containing wax, paraffin, silicone resin, fluororesin, or the like is formed on the film used as the transfer base material.

### <<<Ink>>>

The ink is not particularly limited, and can be selected as appropriate. The ink contains, for example, an organic solvent, water, a colorant, a resin, additives, and the like.

### <<<<Organic Solvent>>>>

The organic solvent can function as a wetting agent in the ink. The organic solvent is not particularly limited, but it is preferable to use an organic solvent with a boiling point of 250° C. or lower because the organic solvent not only functions as a wetting agent, but also provides good drying properties. As such an organic solvent, a water-soluble organic solvent can be used. Examples of the organic solvent include, but are not limited to, polyhydric alcohols, ethers such as polyhydric alcohol alkyl ethers and aryl ethers, nitrogen-containing heterocyclic compounds, amides, amines, and sulfur-containing compounds.

Specific examples of water-soluble organic solvents include, but are not limited to, polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol; polyhydric alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyhydric alcohol aryl ethers such as ethylene glycol monophenyl ether and ethylene glycol monobenzyl ether; polyol compounds having 8 or more carbon atoms; glycol ether compounds; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ¿-caprolactam, and γ-butyrolactone; amides such as formamide, N-methylformamide, N,N-dimethylformamide, 3-methoxy-N,N-dimethylpropionamide, and 3-butoxy-N,N-dimethylpropionamide; amines such as monoethanolamine, diethanolamine, and triethylamine; sulfur-containing compounds such as dimethyl sulfoxide, sulfolane, and thiodiethanol; propylene carbonate; and ethylene carbonate.

Among such water-soluble organic solvents, polyol compounds having 8 or more carbon atoms and glycol ether compounds are preferably used.

Specific examples of polyol compounds having 8 or more carbon atoms include, but are not limited to, 2-ethyl-1,3-hexanediol and 2,2,4-trimethyl-1,3-pentanediol.

Specific examples of glycol ether compounds include, but are not limited to, polyhydric alcohol alkyl ethers such as glycol ethers including ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, triethylene glycol monobutyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, and dipropylene glycol mono-iso-propyl ether; and polyhydric alcohol aryl ethers such as ethylene glycol monophenyl ether and ethylene glycol monobenzyl ether.

Polyol compounds having 8 or more carbon atoms and glycol ether compounds can improve the permeability of the ink when paper is used as the recording medium.

The content of the organic solvent in the ink is not particularly limited and can be selected as appropriate according to the purpose, but from the viewpoint of the drying properties and ejection reliability of the ink, is preferably 10% by mass or more and 60% by mass or less, and more preferably 20% by mass or more and 60% by mass or less.

### <<<<Water>>>>

The content of water in the ink is not particularly limited and can be selected as appropriate according to the purpose, but from the viewpoint of the drying properties and ejection reliability of the ink, is preferably 10% by mass or more and 90% by mass or less, and more preferably 20% by mass or more and 60% by mass or less.

The content of the colorant in the ink is preferably 0.1% by mass or more and 15% by mass or less, and more preferably 1% by mass or more and 10% by mass or less, from the viewpoint of improving the image density, and obtaining good fixability and ejection stability.

Examples of methods of obtaining an ink by dispersing a pigment include, but are not limited to, a method of introducing a hydrophilic functional group into the pigment to obtain a self-dispersing pigment, a method of dispersing the pigment by coating the surface of the pigment with a resin, and a method of dispersing the pigment using a dispersant.

Examples of the method for introducing a hydrophilic functional group into the pigment to obtain a self-dispersible pigment include, but are not limited to, a method of adding a functional group such as a sulfone group or a carboxyl group to make a pigment such as carbon dispersible in water.

Examples of the method of dispersing the pigment by coating the surface of the pigment with a resin include, but are not limited to, a method of enclosing the pigment in microcapsules to make the pigment dispersible in water. A pigment that has been dispersed by coating the surface of the pigment with a resin can also be referred to as a resin-coated pigment. When dispersing a pigment by coating the surface of the pigment with a resin, not all of the pigment incorporated in the ink needs to be coated with the resin, and uncoated pigment or partially coated pigment may be dispersed in the ink to the extent that the effects of the present invention are not impaired.

Examples of the method of dispersing the pigment using a dispersant include, but are not limited to, a method of dispersing a pigment using a known low-molecular weight dispersant or high-molecular weight dispersant, which are represented by surfactants.

As the dispersant, for example, anionic surfactants, cationic surfactants, amphoteric surfactants, nonionic surfactants, and the like can be used depending on the pigment.

PIONINE RT-100 (nonionic surfactant) manufactured by Takemoto Oil & Fat Co., Ltd., and sodium naphthalenesulfonate formalin condensate can also be preferably used as dispersants.

One type of dispersant may be used alone, or two or more types may be used in combination.

### <<<<Pigment Dispersion>>>>

An ink can be obtained by mixing a pigment with materials such as water and an organic solvent. Furthermore, an ink can be produced by preparing a pigment dispersion by mixing a pigment with other materials such as water and a dispersant, and then mixing the pigment dispersion with materials such as water and an organic solvent.

A pigment dispersion is obtained by mixing and dispersing water, a pigment, a pigment dispersant, and other components if preferable, and adjusting the particle size. It is preferable to use a dispersing machine to perform the dispersion.

The particle size of the pigment in the pigment dispersion is not particularly limited. However, from the viewpoint of improving the dispersion stability of the pigment, and improving the ejection stability and image quality such as the image density, the number-based maximum frequency of the particle size is preferably 20 nm or more and 500 nm or less, and more preferably 20 nm or more and 150 nm or less. The particle size of the pigment can be measured using a particle size analyzer (Nanotrac (registered trademark) Wave II-UT151, manufactured by Microtrac MRB).

The content of the pigment in the pigment dispersion is not particularly limited and can be selected as appropriate according to the purpose, but is preferably 0.1% by mass or more and 50% by mass or less, and more preferably 0.1% by mass or more and 30% by mass or less, from the viewpoint of obtaining good ejection stability and increasing the image density.

It is preferable to filter the pigment dispersion by using, if preferable, a filter or a centrifugal separation device to remove coarse particles, followed by degassing of the pigment dispersion.

### <<<<Resin>>>>

The type of resin contained in the ink is not particularly limited and can be selected as appropriate according to the purpose, and examples include, but are not limited to, urethane resins, polyester resins, acrylic resins, vinyl acetate resins, styrene resins, butadiene resins, styrene-butadiene resins, vinyl chloride resins, acrylic styrene resins, and acrylic silicone resins.

Resin particles formed of the resins above may also be used. An ink can be obtained by mixing a resin emulsion, being a state in which resin particles are dispersed in water as a dispersion medium, with materials such as a colorant and an organic solvent. The resin particles may be synthesized as appropriate, or commercially available products may be used. Furthermore, one type of resin particles may be used alone, or two or more types of resin particles may be used in combination.

The average particle size of the resin particles is not particularly limited and can be selected as appropriate according to the purpose, but from the viewpoint of obtaining good fixability and high image hardness, is preferably 10 nm or more and 1,000 nm or less, more preferably 10 nm or more and 200 nm or less, and particularly preferably 10 nm or more and 100 nm or less. The average particle size of the resin particles represents the volume average particle size measured using a particle size analyzer (Nanotrac Wave II-UT151, manufactured by Microtrac MRB) using a dynamic light scattering method.

The content of the resin is not particularly limited and can be selected as appropriate according to the purpose, but from the viewpoint of fixability and storage stability of the ink, is preferably 1% by mass or more and 30% by mass or less, and more preferably 5% by mass or more and 20% by mass or less, with respect to the total amount of the ink.

The average particle size of the solid content in the ink is not particularly limited and can be selected as appropriate according to the purpose, but from the viewpoint of enhancing the ejection stability and image quality such as the image density, the number-based maximum frequency of the average particle size of the solid content in the ink is preferably 20 nm or more and 1000 nm or less, and more preferably 20 nm or more and 150 nm or less. The solid content includes resin particles, pigment particles, and the like. The average particle size of the solid content in the ink represents the volume average particle size measured using a particle size analyzer (Nanotrac Wave II-UT151, manufactured by Microtrac MRB) using a dynamic light scattering method.

### <<<<Additives>>>>

A surfactant, an antifoaming agent, a preservative and fungicide, a corrosion inhibitor, a pH adjuster, and the like may be added to the ink if preferable.

### <<<<Surfactant>>>

As the surfactant, any of a silicone-based surfactant, a fluorine-based surfactant, an acetylene glycol-based surfactant, an acetylene alcohol surfactant, an amphoteric surfactant, a nonionic surfactant, and an anionic surfactant can be used.

The silicone-based surfactant is not particularly limited and can be selected as appropriate according to the purpose. It is preferable to use a silicone-based surfactant that does not decompose even at high pH, and examples include, but are not limited to, polydimethylsiloxane having modified side chains, polydimethylsiloxane modified at both ends, polydimethylsiloxane modified at one end, and polydimethylsiloxane having modified side chains and modified at both ends. Further, polyether-modified silicone-based surfactants having a polyoxyethylene group or a polyoxyethylene polyoxypropylene group as a modifying group are particularly preferable because such surfactants exhibit good properties as an aqueous surfactant.

Such surfactants may be synthesized as appropriate, or commercially available products may be used. Commercially available products can be obtained from, for example, BYK-Chemie GmbH, Shin-Etsu Chemical Co., Ltd., Dow Corning Toray Silicone Co., Ltd., Nihon Emulsion Co., Ltd., Kyoeisha Chemical Co., Ltd.

The polyether-modified silicone-based surfactant is not particularly limited and can be selected as appropriate according to the purpose, and examples include, but are not limited to, polyether-modified silicone-based surfactants represented by general formula (1), in which a polyalkylene oxide structure is introduced into the side chain of the Si part of dimethylpolysiloxane.

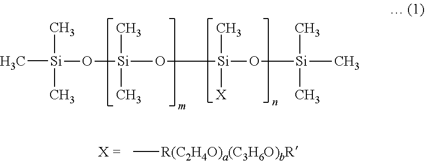

(where, in general formula (1), m, n, a, and b each independently represent an integer, R represents an alkylene group, and R′ represents an alkyl group)

Commercially available products can be used as the polyether-modified silicone-based surfactant described above, and examples include, but are not limited to, KF-353, KF-640, KF-642, KF-643, and KF-644 manufactured by Shin-Etsu Chemical Co., Ltd., EMALEX (registered trademark)-SS-5051 manufactured by Nippon Emulsion Co., Ltd.; BYK (registered trademark)-345, BYK-347, BYK-348, BYK-375, and BYK-377 manufactured by BYK Japan KK; SILFACE (registered trademark) SAG002, SILFACE SAG003, SILFACE SAG005, SILFACE SAG503A, and SILFACE SAG008 manufactured by Nissin Chemical Industry Co., Ltd.; and TEGO (registered trademark)_Wet_KL245, TEGO_Wet_250, TEGO_Wet_260, TEGO_Wet_265, TEGO_Wet_270, and TEGO_Wet_280 manufactured by Evonik Japan Co., Ltd.

As the fluorine-based surfactant, a compound with 2 to 16 fluorine-substituted carbon atoms is preferable, and a compound with 4 to 16 fluorine-substituted carbon atoms is more preferable.

Examples of the fluorine-based surfactant include, but are not limited to, perfluoroalkylsulfonic acid compounds, perfluoroalkylcarboxylic acid compounds, perfluoroalkyl phosphoric acid ester compounds, perfluoroalkylethylene oxide adducts, and polyoxyalkylene ether polymer compounds having a perfluoroalkyl ether group in a side chain.

Examples of perfluoroalkylsulfonic acid compounds include, but are not limited to, perfluoroalkylsulfonic acids and salts of perfluoroalkylsulfonic acids. Examples of perfluoroalkylcarboxylic acid compounds include, but are not limited to, perfluoroalkylcarboxylic acids and salts of perfluoroalkylcarboxylic acids. Examples of polyoxyalkylene ether polymer compounds having a perfluoroalkyl ether group in a side chain include, but are not limited to, sulfate ester salts of polyoxyalkylene ether polymers having a perfluoroalkyl ether group in a side chain, and salts of polyoxyalkylene ether polymers having a perfluoroalkyl ether group in a side chain. Examples of the counter ions of such fluorine-based surfactants include, but are not limited to, Li, Na, K, NH₄, NH₃CH₂CH₂OH, NH₂(CH₂CH₂OH)₂, and NH(CH₂CH₂OH)₃.

Among such surfactants, polyoxyalkylene ether polymer compounds having a perfluoroalkyl ether group in a side chain are preferable because such compounds exhibit low foaming properties, and fluorine-based surfactants represented by the following general formula (2) and general formula (3) are particularly preferable.

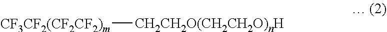

In the compounds represented by the above general formula (2), in order to impart water solubility, m is preferably an integer from 0 to 10, and n is preferably an integer from 0 to 40.

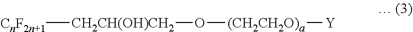

In the compounds represented by the above general formula (3), Y is H, or CₘF₂ₘ₊₁ where m is an integer from 1 to 6, or CH₂CH(OH)CH₂-CₘF₂ₘ₊₁ where m is an integer from 4 to 6, or CₚH₂ₚ₊₁ where p is an integer from 1 to 19. n is an integer from 1 to 6. a is an integer from 4 to 14.

Commercially available products may be used as the fluorine-based surfactant mentioned above. Examples of commercial products include, but are not limited to, SURFLON (registered trademark) S-242, S-243, S-420, and S-431, all manufactured by AGC Seimi Chemical Co., Ltd.; MEGAFAC (registered trademark) F-251, F-430, F-444, F-477, F-552, F-553, and F-554, manufactured by DIC Corporation; CAPSTONE (registered trademark) FS-10, FS-30, FS-31, FS-34, FS-35, FS-51, FS-60, FS-61, FS-63, FS-64, FS-65, and FS-3100, manufactured by DuPont; FTERGENT (registered trademark) 212M, FTERGENT 215M, FTERGENT 250, FTERGENT 251, FTERGENT 222F, and FTERGENT 245F, manufactured by NEOS Co, Ltd.; and POLYFOX PF-136A, PF-156A, and PF-151N, manufactured by Kitamura Chemicals Co., Ltd. Among such commercial products, CAPSTONE FS-3100 and CAPSTONE FS-34 manufactured by DuPont, FTERGENT 250 and FTERGENT 251 manufactured by NEOS Co., Ltd., and POLYFOX PF-151N manufactured by Kitamura Chemicals Co., Ltd. are particularly preferable in that good print quality is obtained, and in particular, the color development, permeability into paper, wettability, and leveling properties significantly improve.

Examples of acetylene glycol-based surfactants and acetylene alcohol-based surfactants include, but are not limited to, nonionic surfactants with an acetylene group in the center and having a symmetrical structure. Such surfactants are “low-foaming wetting agents” and are environmentally friendly.

Commercially available products can be used as the acetylene glycol surfactant and the acetylene alcohol surfactant, and examples of commercial products include, but are not limited to, SURFYNOL (registered trademark) 104E, SURFYNOL 420, SURFYNOL 440, SURFYNOL 465, SURFYNOL SE, SURFYNOL SE-F, SURFYNOL PSA-336, SURFYNOL DF110D, and SURFYNOL DF58, and OLFINE (registered trademark) E1004, OLFINE E1010, OLFINE E1020, OLFINE PD-001, OLFINE PD-002W, OLFINE PD-004, OLFINE PD-005, OLFINE EXP. 4001, OLFINE EXP. 4200, OLFINE EXP. 4123, or OLFINE EXP. 4300, manufactured by Nissin Chemical Industry Co., Ltd.

Examples of the amphoteric surfactant include, but are not limited to, lauryl aminopropionate salts, lauryl dimethyl betaine, stearyl dimethyl betaine, and lauryl dihydroxyethyl betaine.

Examples of the nonionic surfactant include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan fatty acid esters, polyoxyethylene sorbitan fatty acid esters, and ethylene oxide adducts of acetylene alcohol.

Examples of the anionic surfactant include, but are not limited to, salts of polyoxyethylene alkyl ether acetates, dodecylbenzene sulfonates, laurates, and salts of polyoxyethylene alkyl ether sulfates.

One type of surfactant may be used alone, or two or more types may be used in combination.

The content of the surfactant in the ink is not particularly limited and can be selected as appropriate according to the purpose, but from the viewpoint of obtaining excellent wettability and ejection stability, and improved image quality, is preferably 0.001% by mass or more and 5% by mass or less, and more preferably 0.05% by mass or more and 5% by mass or less.

### <<<<Antifoaming Agent>>>>

The antifoaming agent is not particularly limited, and examples include, but are not limited to, silicone-based antifoaming agents, polyether-based antifoaming agents, and fatty acid ester-based antifoaming agents. One type of antifoaming agent may be used alone, or two or more types may be used in combination. Among such antifoaming agents, silicone-based antifoaming agents are preferable since an excellent defoaming effect can be obtained.

### <<<<Corrosion Inhibitor>>>>

The corrosion inhibitor is not particularly limited, and examples of the corrosion inhibitor include, but are not limited to, acid sulfites and sodium thiosulfate.

### <<<<pH Adjuster>>>>

The pH adjuster is not particularly limited as long as the pH adjuster can adjust the pH to 7 or higher, and examples include, but are not limited to, amines such as diethanolamine and triethanolamine.

Examples of methods for qualitatively and quantitatively measuring the organic solvent, the resin, the colorant, and other components contained in the ink include, but are not limited to, the gas chromatography-mass spectrometry (GC-MS) method. Examples of measurement devices using the gas chromatography-mass spectrometry (GC-MS) method include, but are not limited to, GCMS-QP2020NX (manufactured by Shimadzu Corporation). In addition, the amount of water contained in the ink can be measured by general methods such as quantification of volatile components by gas chromatography-mass spectrometry (GC-MS) or by mass changes observed using thermogravimetry-differential thermal analysis (TG-DTA).

The physical properties of the ink are not particularly limited and can be selected as appropriate according to the purpose. For example, it is preferable that the viscosity, surface tension, pH, and the like are within the following ranges.

The viscosity of the ink at 25° C. is preferably 5 mPa's or more and 30 mPa's or less, and more preferably 5 mPa's or more and 25 mPa's or less, from the viewpoint of improving the print density and character quality, and obtaining good ejection properties. Here, the viscosity can be measured, for example, by a rotational viscometer (RE85L, manufactured by Toki Sangyo Co., Ltd.). The measurement can be performed under measurement conditions of 25° C., use of a standard cone rotor (1°34′×R24), a sample liquid volume of 1.2 mL, a rotation speed of 50 rpm, and a time of 3 minutes.

The surface tension of the ink is preferably 35 mN/m or less, and more preferably 32 mN/m or less at 25° C., from the viewpoint of suitable leveling of the ink on the recording medium and shortening of the ink drying time.

The pH of the ink is preferably 7 to 12, and more preferably 8 to 11, from the viewpoint of preventing corrosion of metal members that come into contact with the ink.

The ink preferably does not contain a colorant. Examples of ink that does not contain a colorant include, but are not limited to, clear ink. By using an ink that does not contain a colorant, the decorative properties of the obtained recorded matter can be improved.

### <<<Ink Application>>>

The method for applying the ink to the transfer base material is not particularly limited and can be selected as appropriate.

Examples of the method of applying the ink include, but are not limited to, an inkjet method, a blade coating method, a gravure coating method, a bar coating method, a roll coating method, a dip coating method, a curtain coating method, a slide coating method, a die coating method, and a spray coating method. Among such methods, the inkjet method is preferable from the viewpoints of ink ejection stability, fine image formation, and productivity.

### <<<Recording Device and Recording Method>>>

When applied by such an inkjet method, the ink of the present disclosure can be suitably used in various recording devices based on the inkjet recording method, such as printers, facsimile devices, copying devices, printer/fax/copier multifunction peripherals, and three-dimensional modeling devices.

In the present disclosure, a recording device refers to a device capable of ejecting ink and various treatment liquids onto a transfer base material. Furthermore, a recording method refers to a method of recording on a transfer base material using the recording device. Here, “recording” means that the ink and various treatment liquids can adhere to the transfer base material, even temporarily.

The recording device may include not only the head part that ejects ink, but also means related to feeding, conveying, and ejecting the recording medium, as well as other devices referred to as pre-processing devices and post-processing devices.

The recording device and recording method may have a heating means used in a heating step, and a drying means used in a drying step. Examples of the heating means and the drying means include, but are not limited to, means that heat and dry a printed surface and a rear surface of a recording medium. The heating means and drying means are not particularly limited, and for example, a hot air heater or an infrared heater can be used. Heating and drying can be performed before printing, during printing, or after printing.

The recording device includes both a serial-type device that moves the ejection head and a line-type device that does not move the ejection head, unless otherwise specified.

In addition, the recording device includes not only desktop-type devices, but also wide-format recording devices capable of printing on AO size recording media, and continuous form printers capable of using continuous paper wound in a roll as a recording medium.

An example of a recording device will be described with reference to FIGS. 1 and 2. FIG. 1 is a diagram illustrating an example of the recording device. FIG. 2 is a diagram illustrating an example of a main tank in the recording device. An image forming device 400, which is an example of a recording device, is a serial-type image forming device.

A mechanism unit 420 is provided inside a housing 401 of the image forming device 400. For example, each ink container 411 of main tanks 410 (410k, 410c, 410m, and 410y) for each color, such as black (K), cyan (C), magenta (M), and yellow (Y), is formed of a packaging member such as an aluminum laminate film.

The ink container 411 is accommodated, for example, in a plastic storage container case 414. As a result, the main tank 410 can be used as an ink cartridge for each color.

Note that color inks are not limited to black (K), cyan (C), magenta (M), and yellow (Y) inks, and may be other inks such as white ink, metallic ink, and clear ink. The same applies to the main tank 410 of each color and each ink container 411.

On the other hand, a cartridge holder 404 is provided at the back side of an opening when a cover 401c of the device main body is opened. The main tank 410 is detachably mounted on the cartridge holder 404. As a result, each ink outlet 413 of the main tank 410 communicates with an ejection head 434 for each color via a supply tube 436 for each color, enabling the ejection of ink from the ejection head 434 onto a recording medium.

In addition, the main tank 410 or the ink container 411 for each color may be filled with a pre-treatment liquid or a post-treatment liquid instead of ink, and ejected from the ejection head 434 onto the recording medium.

### <<<<Pre-Treatment Liquid>>>>

The pre-treatment liquid contains an aggregating agent, an organic solvent, and water, and may contain a surfactant, an antifoaming agent, a pH adjuster, a preservative and fungicide, a rust inhibitor, and the like, if preferable. As the organic solvent, surfactant, antifoaming agent, pH adjuster, preservative and fungicide, and rust inhibitor, the same materials used for the ink can be used, and in addition, materials used in known treatment liquids can be used. The type of aggregating agent is not particularly limited, and examples include, but are not limited to, water-soluble cationic polymers, acids, and polyvalent metal salts.

### <<<<Post-Treatment Liquid>>>>

The post-treatment liquid is not particularly limited as long as the post-treatment liquid can form a transparent layer. The post-treatment liquid is obtained by selecting and mixing an organic solvent, water, a resin, a surfactant, an antifoaming agent, a pH adjuster, a preservative and fungicide, a rust inhibitor, and the like, as desired. The post-treatment liquid may be applied to the entire area of the recording region formed on the recording medium, or may be applied only to the area on which an ink image has been formed.

The recording device may include not only the head part that ejects ink, but also means related to feeding, conveying, and ejecting the recording medium, as well as other devices referred to as pre-processing devices and post-processing devices.

As one aspect of the pre-processing device and the post-processing device, similarly to the case of black (K), cyan (C), magenta (M), and yellow (Y) inks, a liquid container having a pre-treatment liquid or a post-treatment liquid and a liquid ejection head is added, and the pre-treatment liquid or the post-treatment liquid is ejected by the inkjet recording method.

As another aspect of the pre-processing device and the post-processing device, a pre-processing device and a post-processing device based on methods other than the inkjet recording method, such as a blade coating method, a roll coating method, or a spray coating method, are provided.

### <<<<Applications of Ink>>>>

In the present disclosure, the application of the ink is not particularly limited and can be selected as appropriate according to the purpose. For example, the ink can be applied to printed articles, paints, coating materials, and base coatings. Furthermore, the ink can be used not only to form two-dimensional text and images by being used as an ink, but also as a three-dimensional modeling material for forming a three-dimensional solid object (three-dimensional modeled object).

As a three-dimensional modeling device for modeling a three-dimensional object, a known device can be used and is not particularly limited. However, for example, a device equipped with an ink storage means, a supply means, an ejection means, a drying means, and the like, can be used. The three-dimensional modeled object includes a three-dimensional modeled object obtained by repeatedly applying the ink.

Furthermore, molded products obtained by processing a structure in which ink is applied onto a base material such as a recording medium are also included. The molded product is an article in which a recorded matter or structure formed in a sheet or film shape has been subjected to molding processing such as heat stretching or die cutting, and for example, is suitably used for applications where molding is performed after surface decoration, such as the panels of meters and operation unit of automobiles, OA equipment, electrical and electronic equipment, cameras, and the like.

### <<<Transfer Image>>>

The transfer image is an image recorded by applying ink to a transfer base material. The transfer image is not particularly limited and can be selected as appropriate. Examples of the transfer image include, but are not limited to, characters, figures, patterns, symbols, and combinations thereof. Moreover, the transfer image is not limited to a two-dimensional image, and may be a three-dimensional image.

### <<Transfer Film Forming Step>>

In the transfer film forming step S2, a binder powder is applied onto the image formed on the transfer base material to form a transfer film. The image formed on the transfer base material is the image formed on the transfer base material in the transfer image forming step S1.

### <<<Binder Powder>>>

The binder powder contains a hot melt powder and a luster pigment. The binder powder of the present disclosure is a luster pigment-mixed hot melt powder obtained by mixing a luster pigment with a hot melt powder. The method of mixing the luster pigment and the hot melt powder is not particularly limited, as long as the method is capable of uniform mixing.

### <<<Hot Melt Powder>>>

The hot melt powder is a binder in the form of a powder that melts upon heating. The hot melt powder is not particularly limited, and can be selected as appropriate. Examples of the material of the hot melt powder include, but are not limited to, polyurethane, EVA (ethylene-vinyl acetate copolymer), polyolefin, synthetic rubber (elastomer), polyamide, and polyester. The materials may be used alone, or two or more types may be used in combination.

Among these materials, polyurethane, polyester, and polyamide are preferable from the viewpoint of increasing the adhesive strength of the binder powder. Furthermore, polyurethane is more preferable from the viewpoint of improving the print strength of the resulting recorded matter.

The melting point of the hot melt powder is not particularly limited, and is, for example, 90° C. or more and 150° C. or less.

The average particle size of the hot melt powder is not particularly limited, and is, for example, 50 μm or more and 300 μm or less. The average particle size of the hot melt powder represents the volume average particle size measured using a particle size analyzer (Nanotrac Wave II-UT151, manufactured by Microtrac MRB) using a dynamic light scattering method.

As the hot melt powder, a hot melt powder for DTF transfer can be used.

### <<<Luster Pigment>>>

A luster pigment refers to a pigment that exhibits luster.

The luster pigment has an average particle size of 10 μm or more and 1,000 μm or less. In the present disclosure, the average particle size of the luster pigment represents a volume average particle size measured using a particle size analyzer (Nanotrac Wave II-UT151, manufactured by Microtrac MRB) using a dynamic light scattering method.

In the resulting recorded matter, because the transfer image is formed on the binder layer, if the average particle size of the luster pigment is too small, the decorative properties will be poor. In addition, when applying the binder powder, the luster pigment is likely to be scattered as dust, which is not preferable from the viewpoint of the working environment.

On the other hand, if the average particle size of the luster pigment is too large, because the luster pigment is removed when excess binder powder is removed by vibration or the like during application of the binder powder, sufficient decorative properties are not obtained. Also, the adhesion area of the hot melt powder to the luster pigment becomes smaller, which reduces the print strength of the resulting recorded matter.

The average particle size of the luster pigment is 10 μm or more and 1,000 μm or less, preferably 11 μm or more and 900 μm or less, more preferably 12 μm or more and 800 μm or less, still more preferably 400 μm or less, and particularly preferably 100 μm or less, from the viewpoint of improving the print strength of the resulting recorded matter.

The material of the luster pigment is not particularly limited as long as the material is stable to heating during heat pressing. Specifically, any luster pigment having a structure that is stable to heating from 150° C. to 200° C. may be used.

Examples of such a material of the luster pigment include, but are not limited to, mica, metal oxide-coated aluminum, metal oxide-coated silica, and metal-coated polyester. The luster pigments may be used alone, or two or more types may be used in combination. Among such materials, mica is preferable from the viewpoint of improving the decorative properties, such as a pearl-like effect.

The content of the luster pigment in the binder powder is 0.6% by mass or more and 15% by mass or less, preferably 0.8% by mass or more and 13% by mass or less, and more preferably 1% by mass or more and 10% by mass or less of the hot melt powder. Here, the content of the luster pigment in the binder powder represents the mixing ratio of the luster pigment with respect to the hot melt powder. If the content of the luster pigment is less than the above range, sufficient decorative properties are not obtained, and if the content is more than the above range, the print strength of the resulting recorded matter decreases.

### <<<Application of Binder Powder>>

The method of applying the binder powder to the transfer image is, for example, a method in which the binder powder is brought into contact with the transfer image, and then removing the excess adhering binder powder by vibration or the like, and heating the powder to a temperature greater than or equal to the melting point of the hot melt powder in the binder powder. The removal of the binder powder by vibration or the like may be performed using a device referred to as a shaker that can continuously perform a series of steps, or the removal of the binder powder may be performed manually.

### <<<Transfer Film>>>

The transfer film is a transfer base material in a state where the binder powder has been applied onto the transfer image having been formed on the transfer base material.

In the production method of the transfer film, for example, the transfer base material on which the transfer image has been formed is transported to a shaker, and the binder powder is made to adhere in the shaker. In the shaker, excess binder powder is removed as desired, and the transfer film is completed by heat treatment (baking). As a result of connecting a DTF printer and a shaker, the process from the formation of the transfer image to the production of the transfer film can be automated.

### <<Transfer Step>>

In the transfer step S3, the transfer film is heat-pressed onto a recording medium, and then the transfer base material is released to transfer the transfer image to the recording medium. For example, the transfer image is transferred to the recording medium by placing the transfer film on the recording medium followed by heat pressing with an iron or a heat press, and then removing the transfer base material. Note that the recording medium onto which the transfer image has been transferred constitutes a recorded matter. Such a recorded matter is sometimes called a DTF printed article.

### <<<Recording Medium>>>

The recording medium is not particularly limited, and plain paper, glossy paper, special paper, cloth, and the like can be used, and further, a non-permeable base material can also be used. A non-permeable base material is a base material having a surface with low water permeability and absorbency, and also includes materials that have a large number of cavities on the inside but are not open to the outside. More quantitatively, the non-permeable base material refers to a base material with a water absorption amount of 10 mL/m² or less within 30 msec^{1/2} from the start of contact in the Bristow method.

As the non-permeable base material, for example, plastic films such as vinyl chloride resin films, polyethylene terephthalate (PET) films, polypropylene, polyethylene, and polycarbonate films can be preferably used.

The recording medium is not limited to those used as a general recording medium mentioned above, and building materials such as wallpaper, flooring, and tiles, cloth for clothing such as T-shirts, textiles, and leather can be used as appropriate. In addition, by adjusting the configuration of the path for transporting the recording medium and the shape of the ejection head, printing can be performed not only on planar objects but also on three-dimensional objects. Furthermore, ceramics, glass, concrete, metal, and the like can also be used as the recording medium.

According to the image forming method of the present disclosure, because the average particle size of the luster pigment is 10 μm or more and 1,000 μm or less, and the content of the luster pigment in the binder powder is 0.6% by mass or more and 15% by mass or less of the hot melt powder, a recorded matter having excellent decorative properties and print strength can be obtained.

### <Recorded Matter>

The recorded matter of the present disclosure is formed by the image forming method of the present disclosure. The image forming method for forming the recorded matter of the present disclosure includes the transfer image forming step S1, the transfer film forming step S2, and the transfer step S3, wherein the average particle size of the luster pigment is 10 μm or more and 1,000 μm or less, and the content of the luster pigment in the binder powder is 0.6% by mass or more and 15% by mass or less of the hot melt powder.

Specifically, the recorded matter of the present disclosure is obtained by the recording device and recording method described above. The obtained recorded matter has an image formed using ink on a recording medium.

Because the recorded matter of the present disclosure is formed by the image forming method of the present disclosure, the effects of the image forming method of the present disclosure can be obtained. Specifically, the recorded matter of the present disclosure has excellent decorative properties and print strength.

### EXAMPLES

The present invention will now be described in detail below with reference to Examples and Comparative Examples, but the scope of the present invention is not limited to such Examples. Various tests and evaluations were conducted with respect to the Examples and Comparative Examples according to the following methods.

Table 1 presents the abbreviations, manufacturer names, and product names of the materials used in the Examples and Comparative Examples, and the average particle size of the luster pigments.

TABLE 1

| | | | Average |
|---|---|---|---|
| | | | particle size |
| | Abbreviation | Manufacturer name and product name | [μm] |
| Hot melt powder | TPU-5 | TPU-5 (manufactured by STS Inks) | |
| Luster pigment | SXA | TWINCLEPEARL SXA (manufactured by Nihon Koken Kogyo Co. Ltd.) | About 9 |
| | SXB | TWINCLEPEARL SXB (manufactured by Nihon Koken Kogyo Co. Ltd.) | About 13 |
| | SX | TWINCLEPEARL SX (manufactured by Nihon Koken Kogyo Co. Ltd.) | About 90 |
| | FT | TWINCLEPEARL FT (manufactured by Nihon Koken Kogyo Co. Ltd.) | About 700 |
| Transfer base | V3 | DTF Cold Peel 48 in × 328 ft Roll (V3) (manufactured by STS Inks) | |
| material | | | |
| Inkjet ink | White | Pro DTF Ink Cartridge White D1600 (manufactured by Ricoh Company, | |
| | | Ltd.) | |
| | Clear | AR ink Cartridge Clear L5160 (manufactured by Ricoh Company, Ltd.) | |

### <Ink>

The inkjet inks presented in Table 1 were used as the ink.

### <Preparation of Binder Powder>

The hot melt powders and luster pigments presented in Table 2 and Table 3 were weighed into 50 mL glass bottles and mixed for 5 minutes at 2,200 rpm using a shaker (VXR basic Vibrax, manufactured by IKA-Werke GmbH & Co. KG) to prepare the binder powders (powders 1 to 15). The units of the numbers in Tables 2 and 3 are g.

TABLE 2

| | Abbreviation | Powder 1 | Powder 2 | Powder 3 | Powder 4 | Powder 5 | Powder 6 | Powder 7 | Powder 8 |
|---|---|---|---|---|---|---|---|---|---|
| Hot melt | TPU-5 | 19.0 | 18.0 | 19.8 | 19.0 | 18.0 | 19.8 | 19.0 | 18.0 |
| powder | | | | | | | | | |
| Luster | SXB | 1.0 | 2.0 | | | | | | |
| pigment | SX | | | 0.2 | 1.0 | 2.0 | | | |
| | FT | | | | | | 0.2 | 1.0 | 2.0 |
| | SXA | | | | | | | | |

TABLE 3

| | Abbreviation | Powder 9 | Powder 10 | Powder 11 | Powder 12 | Powder 13 | Powder 14 | Powder 15 |
|---|---|---|---|---|---|---|---|---|
| Hot melt powder | TPU-5 | 19.8 | 19.0 | 18.0 | 16.0 | 16.0 | 16.0 | 16.0 |
| Luster pigment | SXB | | | | | 4.0 | | |
| | SX | | | | | | 4.0 | |
| | FT | | | | | | | 4.0 |
| | SXA | 0.2 | 1.0 | 2.0 | 4.0 | | | |

### Examples 1 to 10, Comparative Examples 1 to 7

Using a garment printer (Ri 100, manufactured by Ricoh Company, Ltd.), the inks presented in Tables 4 and 5 were applied to the transfer base material presented in Table 1 so that the ink application amount was from 3.0 to 4.5 mg/cm². Then, the binder powders (powders 1 to 15) presented in Tables 4 and 5 were sprayed thereon, and after removing excess powder by applying vibration from the base material surface side, heating was performed at 130° C. for 5 minutes to produce a transfer film. Next, the transfer film and a black polyester fabric serving as a recording medium were heat pressed at 130° C. for 1 minute, and after natural cooling, the transfer base material was released to produce a DTF printed article as a recorded matter.

### <Decorative Properties>

The decorative properties of the obtained recorded matters was evaluated. The evaluation of decorative properties was performed by visual inspection according to the following criteria.

### [Evaluation Criteria]

A: Excellent (luster obtained)
B: Good (no luster obtained, but decorative properties obtained due to pigment)
C: Poor (no decorative properties)

### <Dry Rubbing Robustness>

With respect to the obtained recorded matter, a rubbing resistance test was conducted using a dyed fabric rubbing robustness tester (AR-2, manufactured by Intec Co., Ltd.) to evaluate the dry rubbing robustness as the print strength of the recorded matter. The rubbing resistance test was performed by placing a metal cloth on an image surface of the recorded matter, and the recorded matter was rubbed with a load of 200 g. The evaluation of dry rubbing robustness was performed by visual inspection according to the following criteria.

### [Evaluation Criteria]

A: Excellent (no peeling)
B: Good (slight peeling)
C: Poor (noticeable peeling)

TABLE 4

| Example | 1 | 2 | 3 | 4 | 5 | 6 | 7 | 8 | 9 | 10 |
|---|---|---|---|---|---|---|---|---|---|---|
| Powder | 1 | 2 | 3 | 4 | 4 | 5 | 6 | 7 | 7 | 8 |
| Inkjet ink | Clear | Clear | Clear | Clear | White | Clear | Clear | Clear | White | Clear |
| Luster | A | A | A | A | B | A | A | A | B | A |
| Dry rubbing | A | A | A | A | A | A | B | B | B | B |
| robustness | | | | | | | | | | |

TABLE 5

| | Comparative Example | | | | | | |
|---|---|---|---|---|---|---|---|
| | 1 | 2 | 3 | 4 | 5 | 6 | 7 |
| Powder | 9 | 10 | 11 | 12 | 13 | 14 | 15 |
| Inkjet ink | Clear | Clear | Clear | Clear | Clear | Clear | Clear |
| Luster | C | C | C | C | A | A | A |
| Dry rubbing | A | A | A | C | C | C | C |
| robustness | | | | | | | |

From Tables 1, 2, and 4, in Examples 1 to 10, the recorded matter that satisfied the conditions that the average particle size of the luster pigment is 10 μm or more and 1,000 μm or less, and the content of the luster pigment in the binder powder is 0.6% by mass or more and 15% by mass or less, had good luster and print strength.

On the other hand, from Tables 1, 3, and 5, in Comparative Examples 1 to 7, the recorded matter that did not satisfy either the condition that the average particle size of the luster pigment is 10 μm or more and 1,000 μm or less, or the condition that the content of the luster pigment in the binder powder is 0.6% by mass or more and 15% by mass or less, had poor luster and/or print strength.

Furthermore, from Tables 1, 2, and 4, in Examples 1 to 6, the recorded matter that satisfied the condition that the average particle size of the luster pigment is 400 μm or less had improved print strength.

In addition, from Tables 1, 2, and 4, in Examples 1 to 4, 5 to 7, and 10, when a clear ink (an ink not containing a colorant) was used, the luster was improved.

The embodiments disclosed above include, for example, the following aspects.

A first aspect is an image forming method that includes:
applying an ink to a transfer base material to form a transfer image;
applying a binder powder onto the transfer image on the transfer base material to form a transfer film; and
heat-pressing the transfer film onto a recording medium and then releasing the transfer base material to transfer the transfer image onto the recording medium.

The binder powder includes a hot melt powder and a luster pigment having an average particle size of 10 μm or more and 1,000 μm or less, and
a content of the luster pigment in the binder powder is 0.6% by mass or more and 15% by mass or less of the hot melt powder.

A second aspect is the image forming method according to the first aspect, in which the luster pigment comprises at least member selected from the group consisting of mica, metal oxide-coated aluminum, metal oxide-coated silica, and metal-coated polyester.

A third aspect is the image forming method according to the first or second aspect, in which the luster pigment comprises mica.

A fourth aspect is the image forming method according to any one of the first to third aspects, in which the ink does is free of a colorant.

A fifth aspect is the image forming method according to any one of the first to fourth aspects, in which the luster pigment has an average particle size of 400 μm or less.

A sixth aspect is the image forming method according to any one of the first to fifth aspects, in which the hot melt powder comprises polyurethane.

A seventh aspect is the image forming method according to any one of the first to sixth aspects, in which the applying the ink includes applying the ink by an inkjet method.

An eighth aspect is a recorded matter formed by the image forming method according to any one of the first to seventh aspects.

The embodiments of the present invention have been described above. However, the present invention is not limited to specific embodiments, and various modifications and changes can be made within the scope of the invention described in the claims.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An image forming method, comprising:
applying an ink to a transfer base material to form a transfer image;
applying a binder powder onto the transfer image on the transfer base material to form a transfer film; and
heat-pressing the transfer film onto a recording medium and then releasing the transfer base material to transfer the transfer image onto the recording medium,
wherein the binder powder includes a hot melt powder and a luster pigment having an average particle size of 10 μm or more and 1,000 μm or less, and
a content of the luster pigment in the binder powder is 0.6% by mass or more and 15% by mass or less of the hot melt powder.

2. The image forming method according to claim 1, wherein the luster pigment comprises at least one member selected from the group consisting of mica, metal oxide-coated aluminum, metal oxide-coated silica, and metal-coated polyester.

3. The image forming method according to claim 1, wherein the luster pigment comprises mica.

4. The image forming method according to claim 1, wherein the ink is free of a colorant.

5. The image forming method according to claim 1, wherein the luster pigment has an average particle size of 400 μm or less.

6. The image forming method according to claim 1, wherein the hot melt powder comprises polyurethane.

7. The image forming method according to claim 1, wherein the applying the ink includes:
applying the ink by an inkjet method.

8. A recorded matter formed by the image forming method according to claim 1.
